(19) United States
(12) Patent Application Publication
(10) Pub. No.: US 2012/0300444 A1
(43) Pub. Date: Nov. 29, 2012

(54) SEUCRING STRAP SYSTEM FOR WORK LIGHT

(75) Inventors: David B. Gibson, Wichita, KS (US); Michael P. Marusiak, Wichita, KS (US)

(73) Assignee: The Coleman Company, Inc., Wichita, KS (US)

(21) Appl. No.: 13/575,642

(22) PCT Filed: Jan. 24, 2011
(86) PCT No.: PCT/US11/22241

§ 371 Date: Jul. 27, 2012

Related U.S. Application Data
(60) Provisional application No. 61/298,866, filed on Jan. 27, 2010.

(51) Int. Cl. F21V 3/00; F21L 4/00

(52) U.S. Cl. 362/186; 362/363

(57) ABSTRACT

A portable electric work light includes a top cap having stainless steel strap retaining bars and an adjustable flexible strap having a releasable fastening means to secure the work light to various surfaces and in multiple orientations.

### TECHNICAL FIELD OF THE INVENTION

The present invention is directed to lights, and more particularly to a system for securing a work light to a surface or object in multiple orientations.

### BACKGROUND OF THE INVENTION

In general, a work light is a portable electric light or lantern, such as a luminaire which is configured to be held by a user or hung from a hook or the like. Work lights are useful for a variety of different applications, including use for light in the outdoors, backup lighting in a power outage, as a source of light to find an object in a dark location or to enable a user to work in areas of low light or where concentrated light is necessary. Because of the wide range of applications for which a work light is useful, it is desirable to provide a simple system for attaching the work light to various surfaces and in multiple orientations.

### SUMMARY OP THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a work light is provided. The work light includes an adjustable flexible strap system to enable the work light to be held by a user or securely attached to a support pole or other structure in a variety of orientations.

Other features of the invention will become apparent from the following detailed description when taken in conjunction with the drawings, in which:

### BRIEF DESCRIPTION OF THE DRAWINGS

FIG. 1 is a perspective view of a work light in accordance with an embodiment;

FIG. 2 is a front plan view of the work light of FIG. 1;

FIG. 3 is a left side elevational view of the work light of FIG. 1;

FIG. 4 is a rear plan view of the work light of FIG. 1;

FIG. 5 is a top plan view of the work light of FIG. 1;

FIG. 6 is a bottom plan view of the work light of FIG. 1;

FIG. 7 is a bottom perspective view of the work light of FIG. 1;

FIG. 8 is a perspective view of the work light of FIG. 1 shown in a first strap configuration; and

FIG. 9 is a perspective view of the work light of FIG. 1 shown in a second strap configuration.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

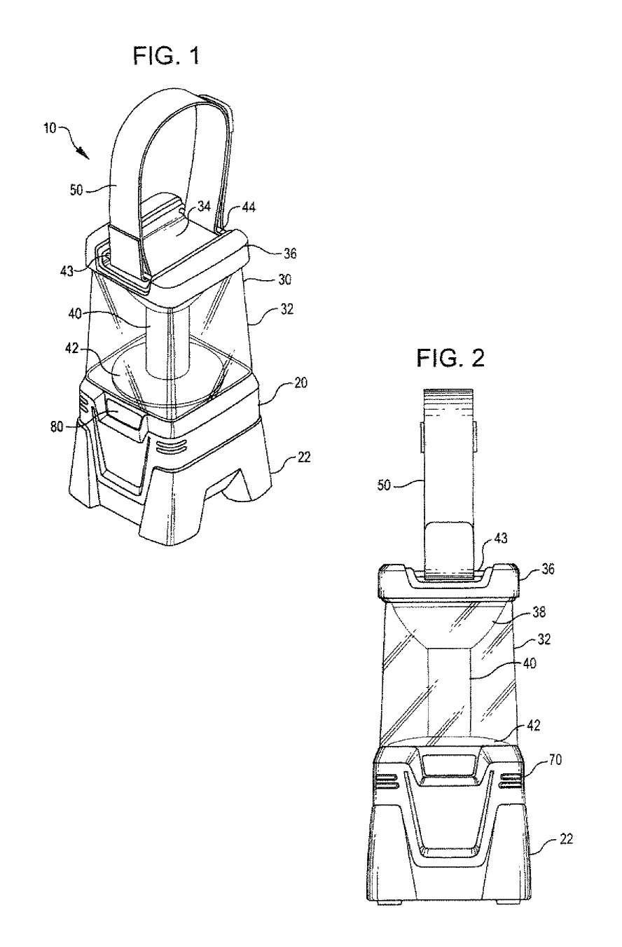

Referring now to the drawings, in which like reference numerals represent like parts throughout the several views, FIG. 1 shows a work light 10 in accordance with an embodiment of the invention. The work light 10 includes a housing assembly 20 and a globe assembly 30. The globe assembly 30 comprises translucent globe 32, top cover 34, bezel 36, top reflector 38, tube lens 40, and bottom reflector 42.

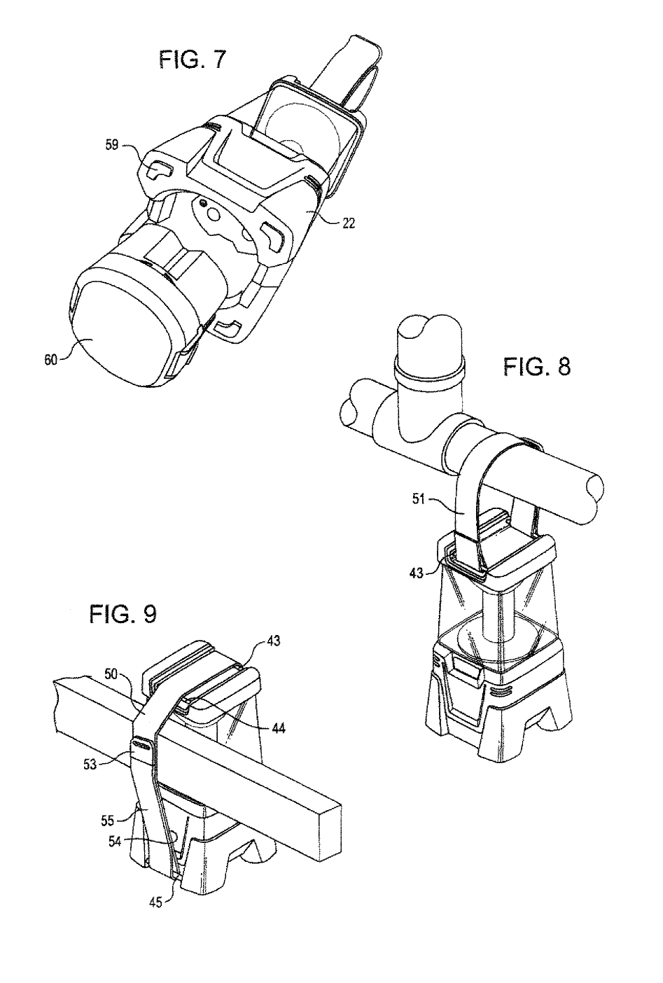

Receptacle 59 is located on the underside of housing assembly 20 defining a cavity for receiving an interchangeable power pack 60, as shown in FIGS. 6 and 7. Preferably, the power pack 60 may be powered with batteries, rechargeable batteries, fuel cells and the like. It is also within the scope of the present invention for receptacle 59 to receive batteries (not shown) that may be mounted therein and secured with a bottom cap (not shown).

Although a tube lens is discussed herein, the work light may include any form of lamp, including a light emitting diode (LED), halogen lamp, an incandescent lamp, a fluorescent lamp, or other lamps or lights. The work light 10 also includes internal wiring (not shown) and a power switch 80 to allow a user to turn the light off and on using the switch. The housing assembly 20 also includes vents 70 to enable air to circulate through the housing 20 to maintain appropriate environmental conditions for the work light as may be required.

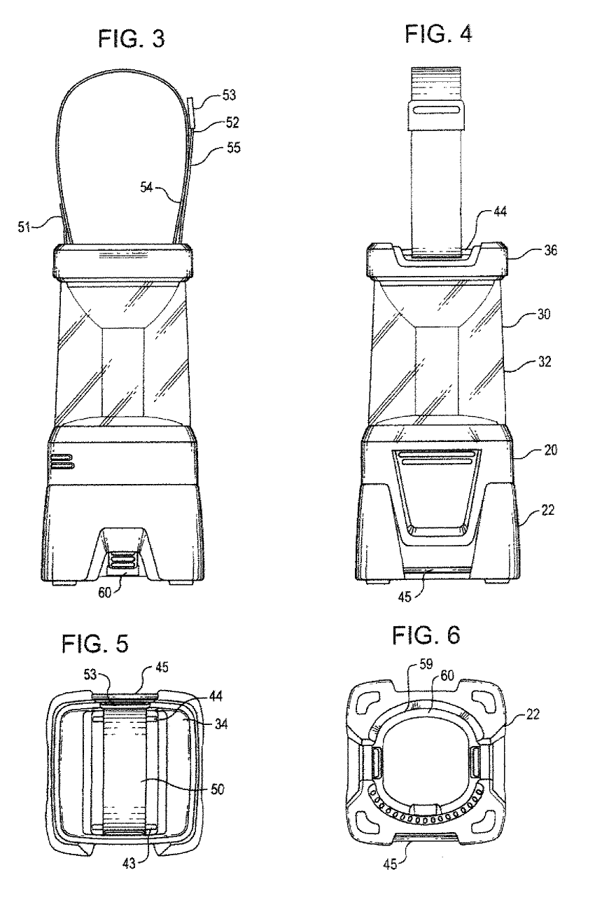

As shown in FIGS. 1-4, globe assembly 30 has a generally square-shaped cross section that flares slightly toward the bottom of the work light such that the bottom of the housing assembly 20 is wider than the top cap 34. Shapes other than generally square are also within the scope of the present invention, provided that such shape allows for a side of the work light to closely abut an object to which it is secured when the adjustable strap system is secured using the third bar 45. Preferably, at least one side of the work light is planar or generally planar to facilitate such contact.

The housing assembly 20 and top cover 34 are preferably made of ABS plastic or another material having similar characteristics and properties known in the industry. Bezel 36 and the base portion 22 of the housing assembly 20 are preferably made of over-molded TPE or rubber, of course, other material that is capable of absorbing impact or providing grip or traction with an object or surface may also be utilized.

Globe assembly 30 includes first and second strap bars 43 and 44 located in parallel orientation to each other on opposite sides of top cover 34 top surface. The bars are connected to the top cover 34 at their ends only and are otherwise spaced apart slightly from the top cover 34 to allow sufficient space for the strap 50 to pass therethrough. The bars 43 and 44 are preferably made of stainless steel and are molded into the top cover 34 or otherwise secured thereto at their respective ends.

Strap 50 comprises a first end 51 and a second end 52. First strap end 52 is permanently attached to first strap bar 43 by looping first end 52 around first bar 43 and securing the strap to itself by means of stitching, adhesive, rivets or the like. Strap 50 is preferably between approximately 12 and 36 inches in length and more preferably between about 15 and 27 inches in length. The width of strap 50 may vary considerably, but is preferably between about 1½ to 3 inches in width and is sufficiently strong to enable the weight of the work light to be secured to surfaces and objects without breakage of the strap. Strap 50 is made of a flexible, high-strength material such as nylon webbing or the like. The dimensions provided herein are not be limiting and straps of larger or smaller lengths and widths may be utilized within the scope of the present invention.

Housing assembly 20 includes base portion 22. Base portion 22 includes third strap bar 45 located on one side at the lower portion thereof in a parallel orientation to first and second strap bars. Third strap bar 45 is also preferably made of stainless steel or other similar material and is similarly molded into base portion 22 or secured thereto at third strap bar ends. Third strap bar 45 is otherwise spaced slightly apart from the body of base portion 22 such that strap 30 may pass between base portion 22 and third strap bar 45.

While strap first end 51 is preferably permanently secured to first bar 43, it is also within the scope of the present invention for first strap end 51 to be removably attached to first bar 43. Regardless of the attachment of first strap end 51 to first bar 43, second strap end 52 comprises releasable fastening means on its exterior side. Releasable fastening means may include a hook and loop fastener, buckles, clips, snaps, buttons, loop and toggle fasteners, or other fastening means known in the industry.

In an embodiment, second strap end 44 includes a molded rubber pull tab 53. Second end 44 preferably includes a hook and loop fastener as the releasable fastening means with either of the hook or loop fastening member secured onto the exterior side of strap along a section between the mid-point 54 and end portion 55 and the corresponding hook or loop fastening member secured onto the exterior side of strap along the strap from the end portion 55 to the pull tab 53, such that the strap 30 may be threaded through the space between the top cap 34 and the second bar 44 and then the strap 30 may be looped around the second bar 44 and secured back onto itself. The hook and loop fastening members are preferably secured to the strap 50 by stitching, but other means such as adhesive or other means known is also within the scope of the present invention.

In operation, second strap end 52 may be secured around second bar 44 or third bar 45. In a first configuration, the strap system of the present invention provides for use as a traditional swinging-style lantern handle where the work light hangs below the strap 50. Second strap end 52 is threaded through the space between second bar 44 and top cover 34 and secured to itself by releasable fastening means. In this first configuration, the loop formed by the strap between the first and second bars may be placed around a hook or the strap may be secured around a bar or other surface for general vertical hanging or may be held by a user as a typical lantern, as shown in FIG. 8.

In a second configuration, the strap 50 is looped over second bar 44 and threaded through the third bar 45 on housing assembly 20, as shown in FIG. 9. In this second configuration, the work light can be secured in a horizontal position to a pole, pipe, or the like to enable the illumination to be directed in a more horizontal direction. In this second configuration, the work light may also be adjusted to direct illumination in multiple orientations by adjusting strap 50 for a snug friction fit between strap 50, work light 10 and the surface to which the work light is mounted. In this configuration, the friction fit and securing strap will allow the work light to be rotated around the mounting surface for direction of illumination.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention otherwise indicated herein or otherwise clearly contradicted by context.

What is claimed is:

1. A light, comprising:
a housing assembly;
a globe assembly; and
an adjustable strap system capable of at least two different strap configurations for securing the light to a surface, the adjustable strap system comprising a pair of strap retaining bars and a flexible strap having releasable fastening means.

2. The light of claim 1, wherein the adjustable strap system further comprises a third strap retaining bar on the base of the housing assembly.

3. The light of claim 2, wherein the third strap retaining bar of the housing assembly is parallel to the pair of strap retaining bars of the globe assembly.

4. The light of claim 1, wherein the releasable fastening means comprises a hook and loop fastener.

5. The light of claim 1, wherein a first end of the flexible strap is permanently secured to a first of the pair of strap retaining bars and a second end of the flexible strap is releasably securable to the second of the pair of strap retaining bars or to the third strap retaining bar using the releasable fastening means.

6. The light of claim 1, wherein the flexible strap is made of nylon webbing.

7. The light of claim 1, further comprising a power source comprising an interchangeable power pack.
